(19) United States
(12) Patent Application Publication
(10) Pub. No.: US 2021/0334594 A1
(43) Pub. Date: Oct. 28, 2021

(54) SCALABLE TRAINING DATA CAPTURE SYSTEM

(71) Applicant: Rehrig Pacific Company, Los Angeles, CA (US)

(72) Inventor: Justin Michael Brown, Coppell, TX (US)

(21) Appl. No.: 17/236,616

(22) Filed: Apr. 21, 2021

Related U.S. Application Data
(60) Provisional application No. 63/014,243, filed on Apr. 23, 2020.

(51) Int. Cl. G06K 9/62; H04N 5/225; H04N 5/235; H04N 5/76

(52) U.S. Cl. CPC G06K 9/6256; H04N 5/76; H04N 5/2354; H04N 5/2256

(57) ABSTRACT

An imaging station includes a rotating pedestal, a camera mover, multiple light sources, and back lit screens. It also includes a computer with all of the software to control the imaging station. The output of the imaging station is a set of images of an object that represents a subset of the ideal set, which can be used to train an object detector.

### BACKGROUND

The ability to detect objects, such as a person or a can of soda, allows applications to exist that would not be possible otherwise, such as self-driving cars and pallet verification. The challenge with creating object detectors is that they require a lot of labeled images which need to be generated by hand. In an ideal scenario, an object detector would be trained with a set of labeled images that were captured with every single possible angle, lighting condition, camera, and camera setting an object could be captured with. In lieu of the ideal training set, a subset that is representative of the ideal set can be used to train object detectors by taking advantage of their ability to generalize. That is, an object detector trained only on a representative subset of the ideal set would be able to detect all objects in the ideal set.

### SUMMARY

An example training data image capture system disclosed herein includes a support surface on which an object to be imaged would be supported. At least one camera is mounted proximate the support surface and positioned to image an object on the support surface. More than one camera could also be used to capture more images more quickly.

At least one light is directed toward the support surface, where the object would be located. Preferably a plurality of lights are directed toward the support surface, again where the object would be located.

A computer is programmed to vary the lighting conditions from the at least one light and to record a plurality of images from the camera at a plurality of lighting conditions from the at least one light.

The computer may further be programmed to cause relative movement between the camera and the support surface between the plurality of images. For example, the computer may be programmed to cause the support surface to rotate relative to the camera. The computer may also be programmed to cause the camera to cause relative rotation between the camera and the object about a horizontal axis. For example, the camera may move along an arc relative to the support surface. The computer and camera record at least one of the plurality of images at each of a plurality of positions of the camera along the arc. The camera may be movable at least 90 degrees on the arc relative to the support surface.

The camera and computer record at least one of the plurality of images at each of a plurality of rotational positions of the support surface (and the object). The system may further include a backlight below the support surface, which may be translucent.

If a plurality of lights are used, the computer is programmed to control the plurality of lights to vary the intensities of each of the plurality of lights independently and to use different intensities and different combinations of intensities from the different lights for each of the plurality of images.

According to a method disclosed herein, a method for creating training data includes capturing a plurality of images of an object at a plurality of angles and capturing the plurality of images of the object under a plurality of different lighting conditions. The method may further include training a machine learning model based upon the plurality of images. The method steps may be controlled by a computer and the images recorded by the computer.

The method may further include providing relative motion between a camera and the object and recording images at varying relative positions. The computer may cause relative motion between the camera and the object and cause a camera to capture the plurality of images at the plurality of angles. The computer may cause at least one light to illuminate the object at a variety of intensities and cause the camera to capture the plurality of images at the variety of intensities.

The example imaging station described herein is designed to capture a representative subset of the ideal set. It is designed primarily for mostly-non-deformable objects, that is, objects that mostly do not move, flex or distort such as a can or plastic bottle of soda. Somewhat deformable objects could also be imaged.

The training station may do this in a scalable fashion in two main parts: one, by automatically capturing images of an object in most angles, many different lighting conditions, and a few different cameras; and two, by automatically segmenting the object from the background, which is used to automatically create labels for the object. The imaging station may also be designed to capture the weight and dimensions of an object.

The example imaging station includes a motorized camera mover that moves the camera in such a way that it captures all vertical angles of an object. The imaging station also includes a motorized pedestal that spins about a vertical axis, allowing the camera to see the object in all horizontal angles. The combination of these two devices allows the imaging station to see most angles of the object

To capture many different lighting conditions, the example imaging station includes a set of lights in many different positions around the object. The goal is to simulate directional lighting, glare, soft lighting, hard lighting, low lighting, and bright light scenarios. The imaging station may also include a device that can cast shadows on an object.

To capture images with a few different cameras, a mounting device can be attached to the camera moving devices, allowing for the attachment of a few different cameras. The camera settings for each camera can be automatically programmed.

To automatically segment the object from the background, the imaging station includes semi-transparent, smooth screens that are back lit using powerful lights. Being back-lit helps segment white objects on a white background. The back-lit screens may take advantage of a camera's Auto White Balance (AWB) feature, which adjusts an image so that the brightest white pixel is true-white, while all other whites appear to be a shade of gray. This creates a visual separation between the white object and the white background, which makes it possible to segment the object from the background. The rotating pedestal is also made up of a semi-transparent material that is lit from the inside out. The floor surrounding the pedestal may also be made of a semi-transparent material that is back lit.

The imaging station may also include a scale underneath the pedestal to capture the weight of an object.

One of the cameras mounted to the motorized camera mover may be a depth camera that produces a depth map in meters for each image. Using this depth map and the object segmentation, a 3-dimensional point cloud of the object is generated in real-world coordinate space. This point cloud allows the user to obtain the length, width and height of the object.

### BRIEF DESCRIPTION OF THE DRAWINGS

FIG. 1 is an isometric perspective of a possible set up of the imaging station.

FIG. 2 is a side perspective of the imaging station.

FIG. 3 is a diagram of the inside-out lit pedestal.

FIG. 4 is a diagram showing use of a back-lighted screen.

FIG. 5 is a sample image of an object without a backlighted screen.

FIG. 6 is a sample image of the object of FIG. 5 with a backlighted screen.

FIG. 7 is a schematic of a machine learning model training system using the imaging station of FIG. 1.

FIG. 8 is a flowchart of a method for training a machine learning model.

### DETAILED DESCRIPTION

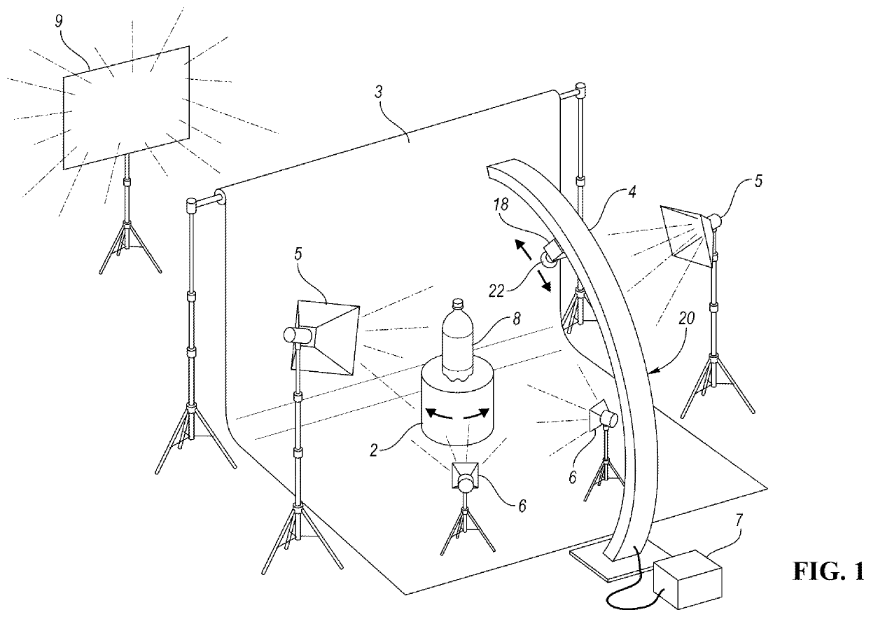

FIG. 1 shows a scalable training data capture system including a camera-moving device 4 holding a camera 22. The camera-moving device 4 may include a shuttle 18 slidably mounted to a track on an arc 20. The arc 20 has a concave front surface facing the object 8, but the arc 20 is not necessarily strictly a segment of a circle and may have a varying, non-constant radius. The shuttle 18 is slidably mounted to the inner, front surface of the arc 20.

FIG. 1 also shows a base or pedestal 2 having a support surface supporting an object 8. The pedestal 2 may be formed of a semi-transparent material, such as a plastic, and may be illuminated from within. The pedestal 2 has a motor that rotates the pedestal 2 on the floor about a vertical axis through the pedestal 2.

Surrounding the pedestal 2 are a plurality of directional soft lights 5 that cause directional lighting, and a plurality of glare lights 6 that cause glare. Behind the pedestal 2 is a semitransparent/translucent screen 3 and its corresponding back-light 9. A computer 7 is programmed to control the entire imaging station, including all of the lights 5, 6 (independently for each light, whether, when and how much to illuminate), the rotation of the pedestal 2, the position of the shuttle 18 and camera 22 on the arc 20, and the operation of the camera 22. The computer 7 also records the images from the camera 22. The computer 7 includes a processor and storage containing suitable programs which when executed by the processor perform the functions described herein.

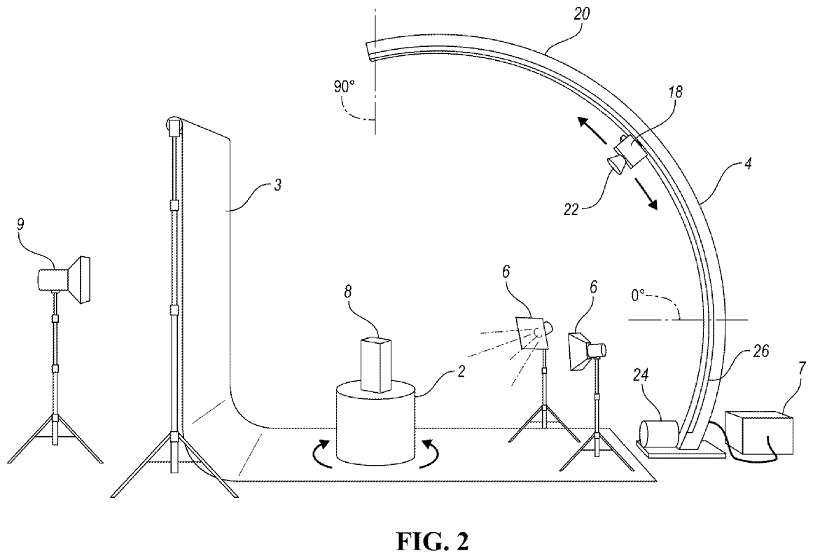

FIG. 2 shows the side view of the imaging station. The camera-moving device 4 would be able to move the camera 22 from 90 degrees (directly above the pedestal 2) to less than 0 degrees by moving the shuttle 18 on the arc 20. The shuttle 18 may include an internal motor driving it along a track on the surface of the arc 20, or a motor inside the arc 20 may move the shuttle 18 along the arc 20, such as via a cable or chain. In FIG. 2, a motor 24 is shown adjacent the base of the arc 20 connected to a cable 26 running inside the arc 20 and connected to the shuttle 18. The motor 24 moves the shuttle 18 in either direction along the arc 20. The rotating pedestal 2 is able to rotate the object 360 degrees about a vertical axis.

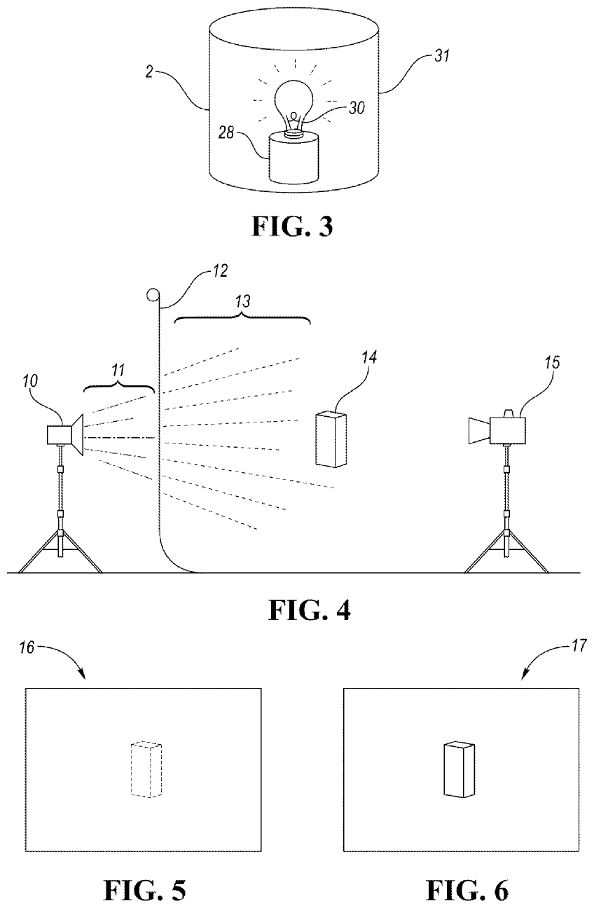

FIG. 3 shows the pedestal 2 with a semitransparent or translucent skin or housing 31 and a light 30 that provides lighting from within. The housing 31 may be a translucent white plastic. A motor 28 inside the pedestal 2 rotates the pedestal 2 about a vertical axis through the pedestal 2. The light 30 and motor 28 are controlled by the computer 7 (FIG. 1).

FIGS. 4-6 explain the benefits of the diffusion of light. The hard light 11 is produced by a light source 10. The hard light 11 passes through the semi-transparent screen 12 which converts it into diffuse light 13. The diffuse light 13 causes the screen 12 to appear very smooth and bright to the camera 15. FIG. 5 shows an image 16 of a white object 14 in front of a white background 12 would look like without backlighting the white background 12. The image 16 is very low-contrast with the background. FIG. 6 shows an image 17 of the same white object 14 in front of the same white background 12, but with the light source 10 turned on. The image 17 shows a higher contrast between the object 14 and the background 12. The backlighting effect shown in FIG. 4 is applicable to both the back-light 9 in FIG. 1 behind the screen 3 and to the light 8 within the pedestal 2.

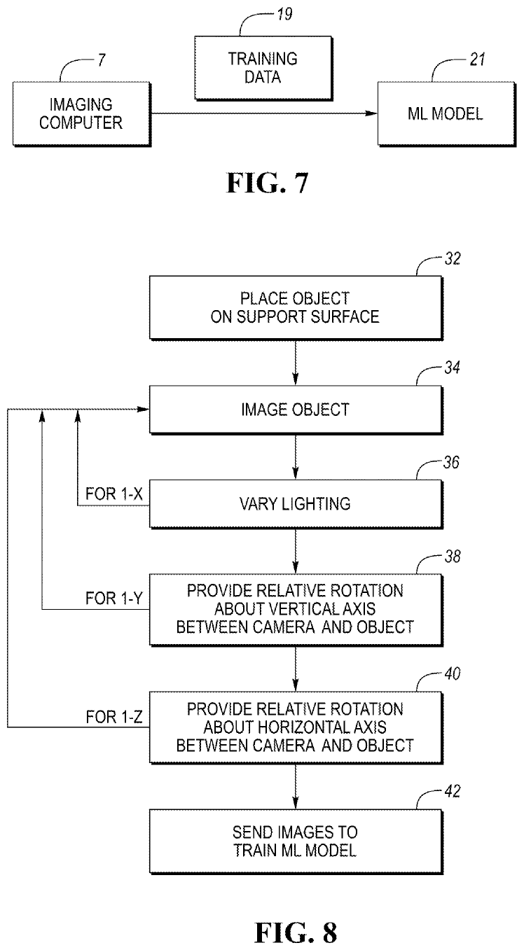

Referring to FIG. 7, the imaging computer 7 sends the training data 19 (i.e. all of the images of the object and an identification of the object) to a machine learning model 21 stored on a computer. The training data 19 is used to train the machine learning model 21 to identify the object in images.

FIG. 8 is a flowchart of the method for training the machine learning model 21. Referring to FIGS. 1-2 and 9, in step 32, the object 8 is placed on the support surface of the pedestal 2. In step 34, the computer 7 controls the camera 22 to take an image of the object 8 at a first relative position under a first lighting condition.

In step 36, the computer 7 controls the lights 5, 6, 9 to vary their intensity independently and to different degrees (including completely off) to produce a variety of lighting conditions on the object 8. At each lighting condition (1 to x), the computer 7 records another image of the object 8 with the camera 22 in step 34.

After all of the lighting conditions have been imaged at the first position, the computer 7 then controls the pedestal 2 and motor 28 to provide relative rotation about a vertical axis between the camera 22 and the object 8 in step 38. The computer 7 images the object 8 in step 34 for every lighting condition again in steps 34-36 at this rotational position.

After all of the rotational positions (1-y) have been imaged at all the lighting conditions (1-x), the camera 22 is moved along the arc 20 (again as controlled by the computer 7) in step 40 to the next relative position about a horizontal axis. At each position of the camera 22 along the arc 20, the pedestal 2 rotates the object 8 through a plurality of positions (1-y) and again, at each rotational position of the object 8, the computer 7 controls the lights 5, 6 to provide the variety of different lighting (optionally shadows) on the object 8, including glare or diffuse lighting (lighting conditions 1-x). Then the camera 22 is moved to the next position on the arc 20 in step 40 and so on. This is repeated for a plurality of positions of the camera 22 all along the arc, from less than zero degrees (i.e. looking up at the object 8) to 90 degrees (i.e. looking straight down onto the object 8). Of course, optionally, less than all of the permutations of the lighting conditions, vertical axis rotational positions, and horizontal axis rotational positions could be used.

The plurality of images of object 8 are collected in this manner by the computer 7 and sent to the machine learning model 21 (FIG. 7) in step 42. The plurality of images of the object 8 are used to train the machine learning model 21 to identify the object 8 stacked with a plurality of other objects. For example, the object 8 may be a beverage container or a case of beverage containers (e.g. a cardboard or paperboard box of cans, or a reusable plastic crate of bottles or cans, or bottles wrapped in plastic wrap, or bottles in a cardboard tray with plastic overwrap, etc). The machine learning model may be trained with the plurality of images to identify the object 8 in a stack of other cases of beverage containers on a pallet to validate an order to be delivered to a store.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Unless otherwise specified in the claims, alphanumeric labels on method steps are for ease of reference in dependent claims and do not indicate a required sequence.

What is claimed is:

1. A training data image capture system comprising:
a support surface;
a camera mounted proximate the support surface and positioned to image an object on the support surface;
at least one light directed toward the support surface; and
a computer programmed to vary lighting conditions from the at least one light and to record a plurality of images from the camera at a plurality of lighting conditions from the at least one light.

2. The system of claim 1 wherein the computer is further programmed to cause relative movement between the camera and the support surface between the plurality of images.

3. The system of claim 2 wherein the computer is further programmed to cause the support surface to rotate relative to the camera.

4. The system of claim 2 wherein the computer is further programmed to cause the camera to move along an arc relative to the support surface and to record at least one of the plurality of images at each of a plurality of positions of the camera along the arc.

5. The system of claim 4 wherein the computer is further programmed to cause the support surface to rotate relative to the camera and to record at least one of the plurality of images at each of a plurality of rotational positions of the support surface.

6. The system of claim 5 further including a backlight behind the support surface, wherein the support surface is translucent.

7. The system of claim 6 wherein the at least one light is a plurality of lights and wherein the computer is programmed to control the plurality of lights to vary the plurality of lights independently and to different intensities for each of the plurality of images.

8. The system of claim 4 wherein the camera is movable at least 90 degrees on the arc relative to the support surface.

9. The system of claim 1 further including a machine learning model trained based upon the plurality of images.

10. A method for creating training data including:
a) capturing a plurality of images of an object at a plurality of angles; and
b) capturing the plurality of images of the object under a plurality of different lighting conditions.

11. The method of claim 10 further including the step of c) training a machine learning model based upon the plurality of images.

12. The method of claim 11 wherein said step a) further includes the step of providing relative motion between a camera and the object.

13. The method of claim 10 wherein said steps a) and b) are automatically performed by a computer.

14. The method of claim 14 wherein the computer causes relative motion between the camera and the object and causes a camera to capture the plurality of images at the plurality of angles in said step a).

15. The method of claim 14 wherein the computer causes at least one light to illuminate the object at a variety of intensities and causes the camera to capture the plurality of images at the variety of intensities.

16. A training data image capture system comprising:
a support surface;
a camera mounted proximate the support surface and positioned to image an object on the support surface; and
a computer programmed to cause relative movement between the camera and the support surface and to record a plurality of images from the camera at each of a plurality of relative positions.

17. The system of claim 16 wherein the computer is further programmed to cause the support surface to rotate relative to the camera.

18. The system of claim 16 wherein the computer is further programmed to cause the camera to move along an arc relative to the support surface and to record at least one of the plurality of images at each of a plurality of positions of the camera along the arc.

19. The system of claim 18 wherein the computer is further programmed to cause the support surface to rotate relative to the camera and to record at least one of the plurality of images at each of a plurality of rotational positions of the support surface.

20. The system of claim 16 further including a machine learning model trained based upon the plurality of images.
